(19) United States
(12) Patent Application Publication
(10) Pub. No.: US 2024/0278576 A1
(43) Pub. Date: Aug. 22, 2024

(54) PRINTING APPARATUS

(71) Applicant: SEIKO EPSON CORPORATION, Tokyo (JP)

(72) Inventor: Masaki SHIMOMURA, MATSUMOTO-SHI (JP)

(21) Appl. No.: 18/652,213

(22) Filed: May 1, 2024

Related U.S. Application Data
(63) Continuation of application No. 17/487,878, filed on Sep. 28, 2021.

(30) Foreign Application Priority Data
Sep. 29, 2020 (JP) 2020-162964

(51) Int. Cl. B41J 2/165

(52) U.S. Cl. CPC B41J 2/16547; B41J 2/16508; B41J 2/16538

(57) ABSTRACT

A printer includes a line head, a cover section, and a discharge tray. The line head performs recording on a medium by ejecting ink from an ejection surface inclined. The cover section is provided to be movable between a facing position at which the cover section faces the line head and a non-facing position located in a downward direction with respect to the facing position and performs maintenance of the line head 40 at the facing position. The discharge tray is provided to be detachably attached to an apparatus main body and has the medium mounted thereon in a state in which the discharge tray is attached to the apparatus main body. In the printer, in a state in which the discharge tray retreats from above the cover section, the cover section is able to be removed in an upward direction.

The present application is a continuation of U.S. application Ser. No. 17/487,878, filed Sep. 28, 2021, which is based on, and claims priority from JP Application Serial Number 2020-162964, filed Sep. 29, 2020, the disclosure of which is hereby incorporated by reference herein in their entirety.

### BACKGROUND

### 1. Technical Field

The present disclosure relates to a printing apparatus.

### 2. Related Art

An ink jet recording apparatus according to JP-A-2018-89851 includes a recording head section, a capping unit including a cap capable of coming into contact with the recording head section, and a cap moving mechanism that moves the capping unit. The capping unit moves toward the front of the apparatus and is attachable/detachable.

In the ink jet recording apparatus described in JP-A-2018-89851, a space for pulling out the capping unit needs to be secured in front of the ink jet recording apparatus. When an installation space of the ink jet recording apparatus has insufficient margin, it may be difficult to replace the capping unit.

### SUMMARY

To address the aforementioned problem, a printing apparatus according to the disclosure includes: a recording section that performs recording on a medium by ejecting a liquid from an ejection surface inclined in an intersecting direction intersecting a vertical direction; a maintenance section that is configured to move between a facing position at which the maintenance section faces the recording section and a non-facing position at which the maintenance section retreats from the ejection surface and which is located in a downward direction with respect to the facing position and that performs maintenance of the recording section at the facing position; and a mounting section which is provided to be detachably attached to an apparatus main body provided with the recording section and the maintenance section and on which the medium discharged is mounted in a state in which the mounting section is attached to the apparatus main body, in which the maintenance section is configured to be removed in an upward direction in a state in which the mounting section is detached from above the maintenance section.

### BRIEF DESCRIPTION OF THE DRAWINGS

FIG. 1 illustrates a transport path of a medium in a printer according to an embodiment.

FIG. 2 is a perspective view illustrating a structure around a line head of the printer according to the embodiment.

FIG. 3 is a perspective view of the line head of the printer according to the embodiment.

FIG. 4 is a perspective view illustrating one of side frames of the printer according to the embodiment.

FIG. 5 is a schematic view illustrating arrangement of sections when the line head of the printer according to the embodiment is at a recording position.

FIG. 6 is a schematic view illustrating arrangement of the sections when the line head of the printer according to the embodiment is at a first maintenance position.

FIG. 7 is a perspective view of a wiper unit of the printer according to the embodiment.

FIG. 8 is a perspective view illustrating a driving unit of the printer according to the embodiment.

FIG. 9 is a schematic view illustrating arrangement of the sections when the line head of the printer according to the embodiment is at a second maintenance position.

FIG. 10 is a schematic view illustrating movement directions of the line head, a capping unit, and the wiper unit of the printer according to the embodiment.

FIG. 11 is a schematic view illustrating a state in which a cover section is removed through a removal section of the printer according to the embodiment.

FIG. 12 is a schematic view illustrating a dimension of each of the sections of the printer according to the embodiment.

### DESCRIPTION OF EXEMPLARY EMBODIMENTS

Hereinafter, the disclosure will be schematically described.

A printing apparatus of a first aspect includes: a recording section that performs recording on a medium by ejecting a liquid from an ejection surface inclined in an intersecting direction intersecting a vertical direction; a maintenance section that is configured to move between a facing position at which the maintenance section faces the recording section and a non-facing position at which the maintenance section retreats from the ejection surface and which is located in a downward direction with respect to the facing position and that performs maintenance of the recording section at the facing position; and a mounting section which is provided to be detachably attached to an apparatus main body provided with the recording section and the maintenance section and on which the medium discharged is mounted in a state in which the mounting section is attached to the apparatus main body, in which the maintenance section is configured to be removed in an upward direction in a state in which the mounting section retreats from above the maintenance section.

According to the present aspect, in the printing apparatus, a space to which the medium recorded by the recording section is discharged is located in the upward direction with respect to the mounting section. When the mounting section retreats from above the maintenance section, the maintenance section at the facing position is exposed when viewed from the space. In this manner, even when no operation space is secured around the printing apparatus, the maintenance section is able to be removed by using the space in the upward direction with respect to the mounting section of the printing apparatus, thus making it possible to easily replace the maintenance section.

In the first aspect, the printing apparatus of a second aspect further includes: a second maintenance section that performs maintenance of the recording section when the maintenance section serves as a first maintenance section; and a first guide and a second guide that guide the second maintenance section in a third direction intersecting both a first direction in which the recording section moves and a second direction in which the first maintenance section moves, in which the second guide is located in an upward direction with respect to the first guide, and the first maintenance section is configured to be removed in an upward direction from between the recording section and the second guide.

According to the present aspect, even with a configuration in which the second maintenance section different from the first maintenance section is provided, the first maintenance section is able to be removed through a space between the recording section and the second guide.

According to the printing apparatus of a third aspect, in the second aspect, in a state in which the first maintenance section is arranged at the facing position, the first maintenance section is located between the first guide and the second guide.

According to the present aspect, since the first maintenance section in a state of being arranged at the facing position is located between the first guide and the second guide, the first maintenance section is able to be removed from between the first guide and the second guide. Thus, it is possible to easily remove the first maintenance section compared with a configuration in which the first maintenance section is removed after moving the first maintenance section to a position different from the facing position.

According to the printing apparatus of a fourth aspect, in the second or third aspect, a distance from the second guide to a central position of the ejection surface is longer than a distance from the first guide to the central position.

According to the present aspect, the second guide is located in the upward direction with respect to the first guide in the vertical direction. The distance from the second guide to the central position of the ejection surface is longer than the distance from the first guide to the central position. Accordingly, it is possible to secure a greater distance between the recording section and the second guide compared with a configuration in which the first guide is located in an upward direction with respect to the second guide, thus making it possible to easily remove the first maintenance section.

In the fourth aspect, the printing apparatus of a fifth aspect further includes: a driving section that drives the second maintenance section in the third direction, in which the second maintenance section includes a guided section guided by the first guide, and the guided section receives a driving force from the driving section.

According to the present aspect, the guided section is located in a downward direction with respect to a portion, which is guided by the second guide, in the vertical direction. When the guided section receives the driving force from the driving section, the second maintenance section moves in the third direction. Accordingly, a configuration in which the driving force is applied from the driving section to the guided section suppresses the first maintenance section to be removed from being interfered, thus making it possible to easily remove the first maintenance section compared with a configuration in which a driving force is applied to the portion guided by the second guide.

According to the printing apparatus of a sixth aspect, in any of the second to fifth aspects, when the recording section is at the facing position, a distance corresponding to a minimum distance from the recording section to the second guide is longer than a distance corresponding to a width of the maintenance section in the first direction.

According to the present aspect, without moving the recording section farther, the maintenance section is able to be removed from between the recording section and the second guide.

According to the printing apparatus of a seventh aspect, in any of the first to sixth aspects, the recording section is configured to move between a recording position at which the recording section is configured to perform recording on the medium and a retreat position away from the recording position, and a movement path of the maintenance section overlaps at least a portion of a movement path of the recording section.

According to the present aspect, the maintenance section and the recording section are able to be arranged close to each other compared with a configuration in which the movement path of the maintenance section and the movement path of the recording section do not overlap, thus making it possible to reduce a size of the printing apparatus.

A printer 1 of an embodiment, which is an example of the printing apparatus according to the disclosure, will be specifically described below.

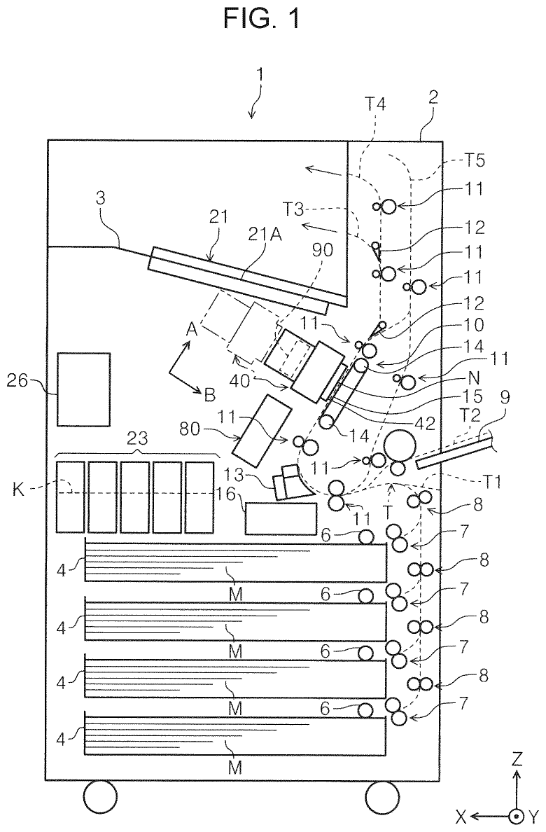

As illustrated in FIG. 1, the printer 1 is configured as an ink jet apparatus that performs recording on a medium M such as recording paper by ejecting ink K, which is an example of the liquid. Note that the X-Y-Z coordinate system illustrated in each drawing is an orthogonal coordinate system.

The X direction is an apparatus width direction when viewed from an operator of the printer 1 and is the horizontal direction. In the X direction, a leftward direction is the +X direction, and a rightward direction is the −X direction.

The Y direction is a width direction of the medium M, which intersects a transport direction of the medium M, an apparatus depth direction, and the horizontal direction. The Y direction intersects both the direction A and the direction B described later. In the Y direction, a frontward direction is the +Y direction, and a rearward direction is the −Y direction. Further, the Y direction is an example of the third direction, in which a wiper unit 90 described later moves, and intersects the Z direction, the direction A, and the direction B.

The Z direction is an apparatus height direction and corresponds to, for example, the vertical direction. In the Z direction, an upward direction is the +Z direction, and a downward direction is the −Z direction. Note that, in the present embodiment, up indicates a direction including a vertically up component, and down indicates a direction including a vertically down component.

In the printer 1, the medium M is transported on a transport path T indicated by the broken line. The A-B coordinate system indicated in the X-Z plane is an orthogonal coordinate system.

The direction A is the transport direction of the medium M in a region of the transport path T, which faces a line head 40 described later. In the direction A, an upstream direction is the direction-A, and a downstream direction is the direction +A. Moreover, the direction A is an example of the intersecting direction, which intersects the Z direction. The direction A is an example of the second direction in which a capping unit 80 described later moves.

In the present embodiment, the direction A is a direction inclined such that a position of the transport path T in the direction +A is located in the +Z direction with respect to a position of the transport path T in the direction −A. Specifically, the direction A is inclined relative to the Z direction at an angle in a range of 20° to 40°, more specifically, at substantially 30°. In other words, the direction A is inclined relative to the X direction at substantially 60°.

The direction B is an example of a direction orthogonal to an ejection surface 42 described later and is a direction in which the line head 40 described later reciprocates with respect to a transport unit 10 described later. The direction B is an example of the first direction in which the line head 40 moves. Further, the direction B is a direction intersecting the Z direction. In the direction B, a direction in which the line head 40 approaches the transport unit 10 is the direction +B, and a direction in which the line head 40 is away from the transport unit 10 is the direction −B. The direction B is a direction inclined such that a position in the direction −B is located in the +Z direction with respect to a position in the direction +B.

The printer 1 includes an apparatus main body 2. The apparatus main body 2 includes a housing serving as a casing. A discharge section 3 having a space to which the recorded medium M is discharged is formed in the +Z direction with respect to the center of the apparatus main body 2 in the Z direction. Moreover, a plurality of media cassettes 4 are provided in the apparatus main body 2.

Media M are stored in the plurality of media cassettes 4. The medium M stored in the media cassettes 4 is transported on the transport path T by a pick-up roller 6 and pairs of transport rollers 7 and 8. A transport path T1 on which the medium M is transported from an external apparatus and a transport path T2 on which the medium M is transported from a manual tray 9 provided in the apparatus main body 2 merge on the transport path T.

The transport unit 10, a plurality of pairs of transport rollers 11 for transporting the medium M, a plurality of flaps 12 for switching a path on which the medium M is transported, and a medium-width sensor 13 for detecting a width of the medium M in the Y direction are arranged on the transport path T.

The transport unit 10 includes two pulleys 14, an endless transport belt 15 wound around the two pulleys 14, and a motor (not illustrated) that drives one of the pulleys 14. The medium M is transported in the direction +A at a position facing the line head 40 described later while the medium M is sucked on a belt surface of the transport belt 15.

The transport path T extends from the medium-width sensor 13 in the direction +A. A transport path T3 and a transport path T4 toward the discharge section 3 and an inverting path T5 on which the medium M are inverted are provided downstream of the transport unit 10 on the transport path T.

An ink container 23 that stores the ink K, a waste-liquid accumulation section 16 that accumulates waste liquid of the ink K, and a control section 26 that controls operation of the respective sections of the printer 1 are provided in the apparatus main body 2. The ink container 23 supplies the ink K to the line head 40 via a tube (not illustrated). The waste-liquid accumulation section 16 accumulates waste liquid of the ink K collected by the wiper unit 90 or the capping unit 80 described later.

The control section 26 includes a central processing unit (CPU), read-only memory (ROM), random access memory (RAM), and storage, which are not illustrated, and controls transportation of the medium M in the printer 1 and operation of the respective sections including the line head 40 and the wiper unit 90.

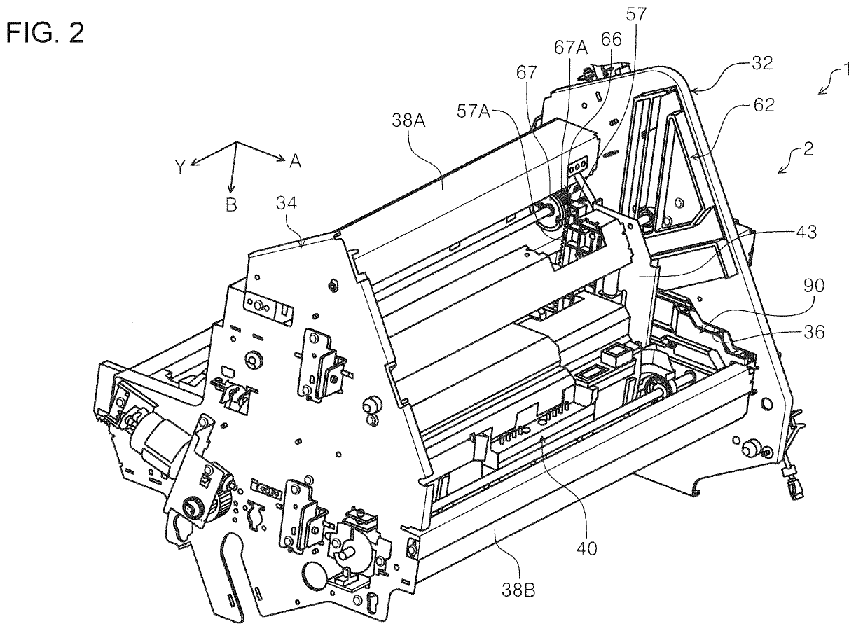

As illustrated in FIG. 2, for example, a side frame 32 and a side frame 34 are provided in the apparatus main body 2 as a pair of side walls. The side frame 32 and the side frame 34 are arranged opposite to each other with a gap therebetween in the Y direction.

The side frame 32 is formed of, for example, sheet metal and stands upright in the A-B plane of the apparatus main body 2. The side frame 32 is arranged in the −Y direction with respect to the center of the apparatus main body 2 in the Y direction. A through hole 36 passes through the side frame 32 in the Y direction. The size and shape of the through hole 36 are set so as to enable the wiper unit 90 described later to pass through the through hole 36 in the Y direction.

The side frame 34 is formed of, for example, sheet metal and stands upright in the A-B plane of the apparatus main body 2. The side frame 34 is arranged in the +Y direction with respect to the center of the apparatus main body 2 in the Y direction. No through hole is formed in the side frame 34. The side frame 32 and the side frame 34 are coupled by lateral frames 38A and 38B, which extend in the Y direction, and another lateral frame (not illustrated). The line head 40 is arranged in a space between the side frame 32 and the side frame 34.

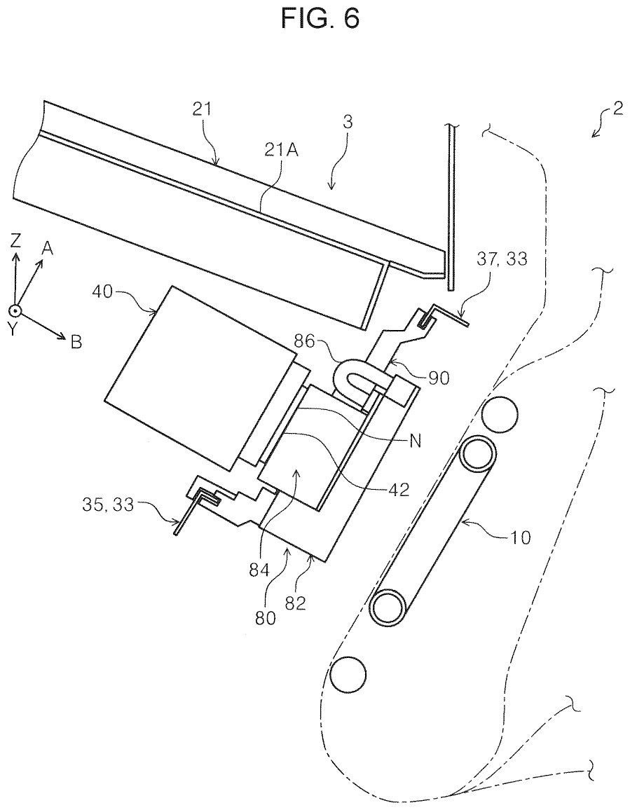

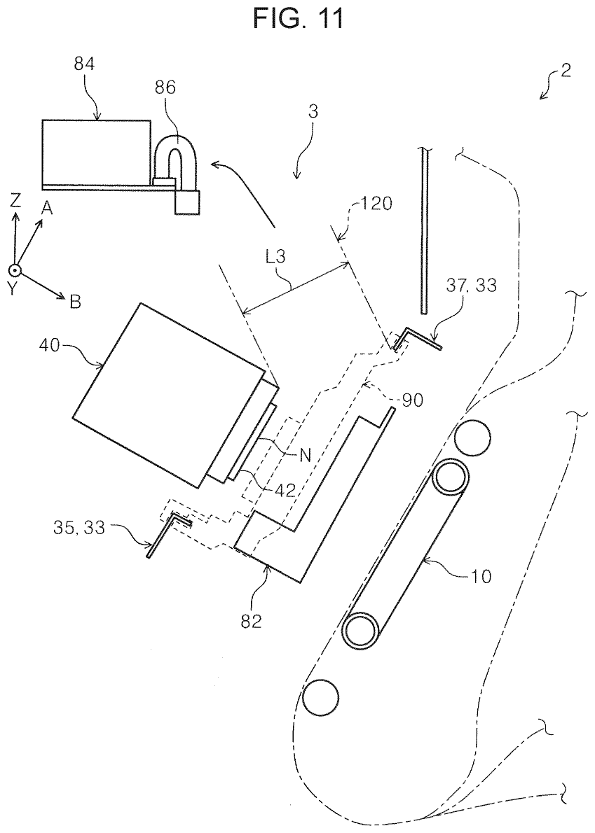

The printer 1 includes, for example, a discharge tray 21 (FIG. 1), a guide section 33 (FIG. 6), the line head 40, a driving unit 50, a rail section 62, the wiper unit 90, a removal section 120 (FIG. 11), and the capping unit 80 (FIG. 1).

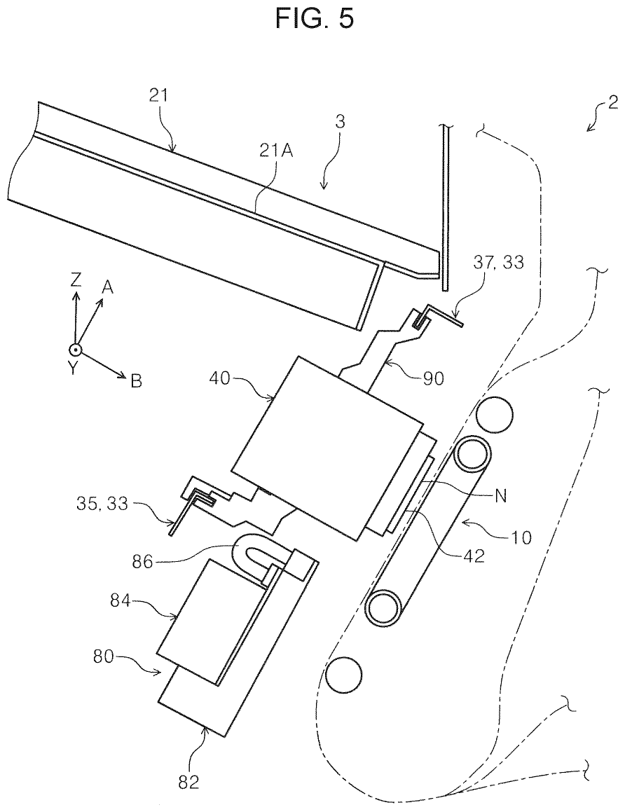

As illustrated in FIG. 1, the discharge tray 21 is detachably attached to the apparatus main body 2, which includes the line head 40 and a cover section 84 (FIG. 5) described later, in an upward direction with respect to the cover section 84. The discharge tray 21 is an example of a mounting section, and the medium M discharged through the transport paths T3 and T4 is mounted on the discharge tray 21 in a state of being attached to the apparatus main body 2. The discharge tray 21 forms a bottom portion of the discharge section 3, which is a space to which the medium M is discharged. Note that a surface of the discharge tray 21, on which the medium M is mounted, is a mounting surface 21A. The mounting surface 21A is inclined such that the +X direction end is located in the +Z direction with respect to the −X direction end.

In a state in which the discharge tray 21 is detached from the apparatus main body 2, the cover section 84 (FIG. 5) described later is able to be removed in the upward direction.

As illustrated in FIG. 2, the line head 40 is an example of the recording section and is provided in the apparatus main body 2 so as to be movable between a recording position and a retreat position described later. The line head 40 is moved in the direction B by a head moving unit 66 described later.

The recording position of the line head 40 is a stop position (FIG. 5) of the line head 40 when the line head 40 is able to record information on the medium M. Note that, since the recording position of the line head 40 is able to be adjusted in the direction B by an adjusting unit (not illustrated), one or more recording positions exist.

The retreat position of the line head 40 is a stop position of the line head 40 when the line head 40 is away from the recording position in the direction-B. The retreat position of the line head 40 includes a standby position at which the line head 40 is able to move to the recording position again, a replacement position (not illustrated) at which the line head 40 is able to be removed from the apparatus main body 2, and a maintenance position at which the line head 40 is subjected to maintenance.

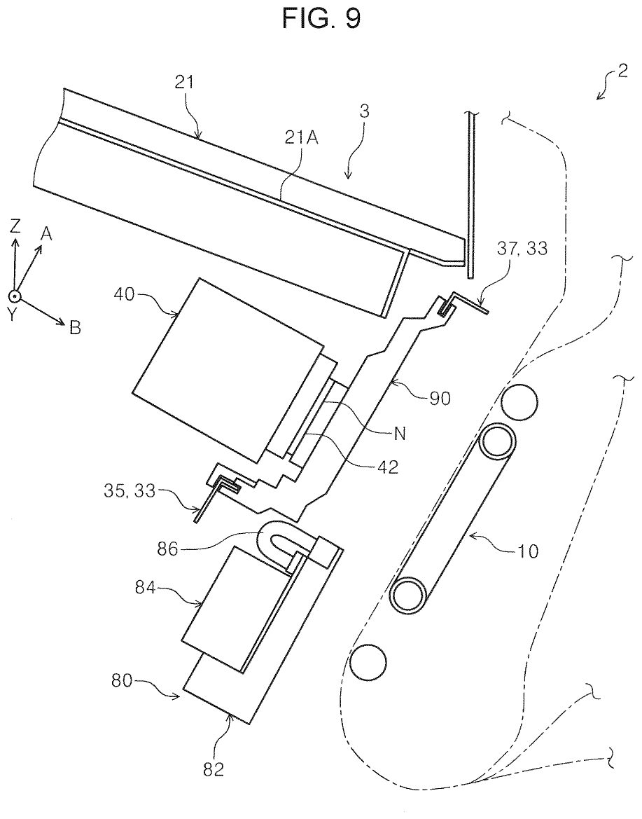

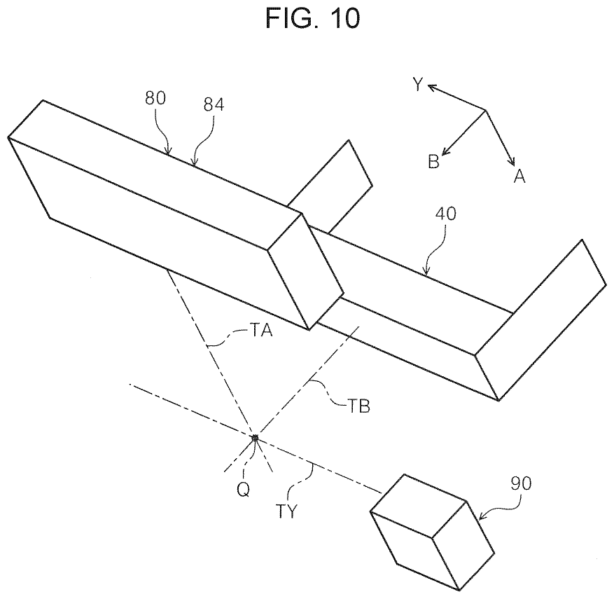

Further, the maintenance position of the line head 40 includes a first maintenance position (FIG. 9) that is a position at which the line head 40 is subjected to maintenance by the capping unit 80 (FIG. 1) and a second maintenance position (FIG. 10) that is a position at which the line head 40 is cleaned by the wiper unit 90.

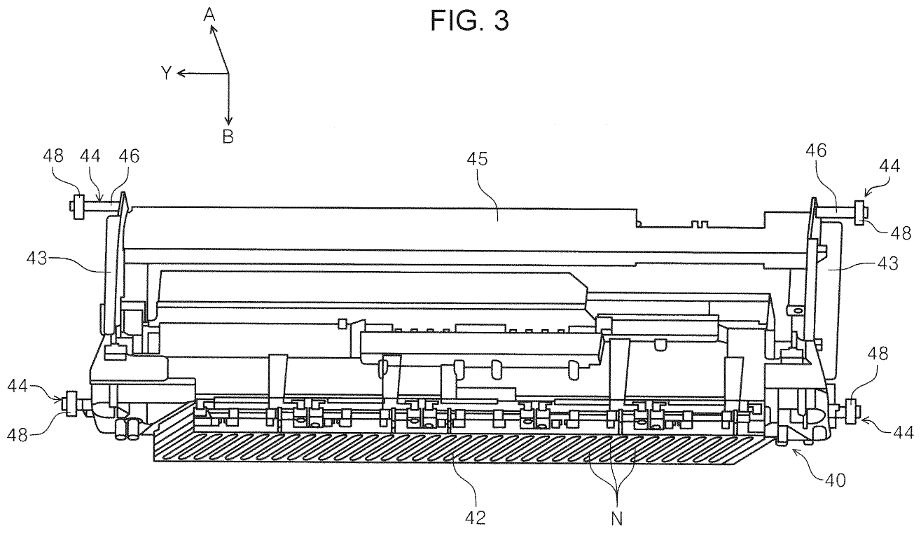

As illustrated in FIG. 3, the line head 40 includes the ejection surface 42. The ejection surface 42 is inclined in the direction A, which intersects the Z direction, and is arranged in the A-Y plane. The ejection surface 42 has a plurality of nozzles N for ejecting the ink K. The plurality of nozzles N extend over the entire region of the medium M in the Y direction. The line head 40 performs recording on the medium M by ejecting the ink K from the plurality of nozzles N on the ejection surface 42 onto the medium M at the recording position.

In this manner, the line head 40 is configured as an ink ejecting head capable of performing recording on the entire region of the medium M in the Y direction without the medium M moving in the Y direction. However, the ink ejecting head is not limited to being configured as the line head 40 and may be configured as a serial type in which ink is ejected while the ink ejecting head mounted on a carriage moves in the Y direction of the medium M.

The line head 40 extends in the Y direction. A single support frame 43 is attached to each end of the line head 40 in the Y direction. The support frame 43 is configured as a side plate in the A-B plane and extends from the line head 40 in the direction-B. The support frames 43 of the pair are coupled by a coupling frame 45 that extends in the Y direction.

Note that the line head 40 and the support frames 43 are arranged between the side frame 32 and the side frame 34 (FIG. 2). That is, the line head 40 is movable in the direction B between the side frame 32 and the side frame 34.

Each of the two support frames 43 includes two protrusions 44 that protrude outward in the Y direction. Each of the protrusions 44 includes a shaft section 46 that extends outward in the Y direction from corresponding one of the support frames 43 and a bearing 48 rotatably provided in a tip end of the shaft section 46. In the support frame 43, a distance corresponding to a gap between the bearing 48 on the direction-B side and the bearing 48 on the direction +B side is longer than a distance corresponding to a length of the through hole 36 (FIG. 2) in the direction B.

As illustrated in FIG. 2, the support frame 43 includes a rack 57. The rack 57 is a plate member having a thickness direction in the Y direction and extends in the direction B. A plurality of tooth sections 57A arrayed in the direction B are formed in the direction-A end of the rack.

The head moving unit 66 is an example of a moving mechanism that moves the line head 40. The head moving unit 66 is configured to enable the line head 40 to move between the recording position and the retreat position such that the line head 40 reciprocates in the direction B with respect to the transport belt 15 (FIG. 1). In other words, the head moving unit 66 moves the line head 40 in the direction B such that the movement direction of the line head 40 intersects both the vertical direction and the horizontal directions.

The head moving unit 66 includes a pinion 67 and a motor (not illustrated) for rotating the pinion 67, and driving of the head moving unit 66 is controlled by the control section 26 (FIG. 1). A tooth section 67A formed on the outer peripheral surface of the pinion 67 engages a tooth section 57A. Accordingly, when the pinion 67 rotates in the positive direction, the line head 40 moves to the recording position, and when the pinion 67 rotates in the opposite direction, the line head 40 moves to the retreat position.

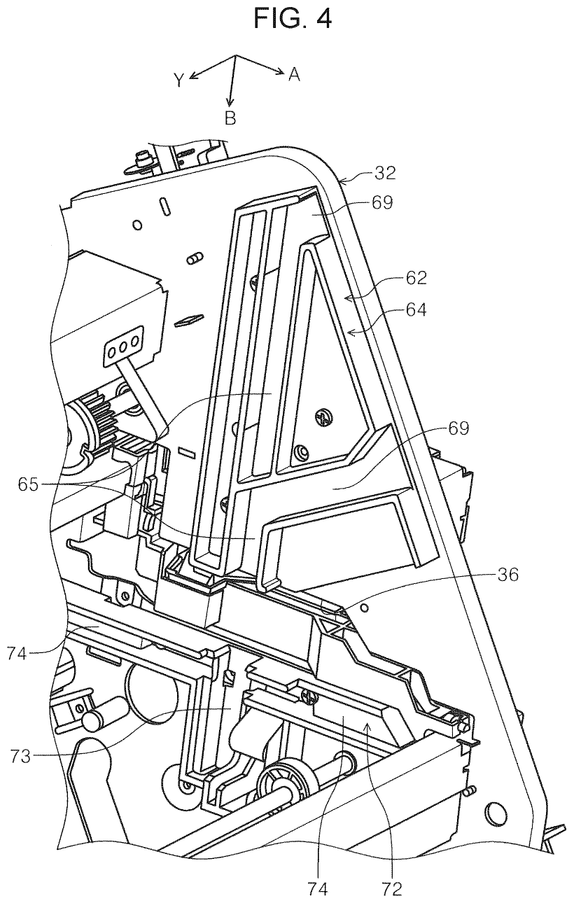

As illustrated in FIG. 4, the rail section 62 that guides the line head 40 (FIG. 1) in the direction B is provided on the side frame 32. The through hole 36 divides the rail section 62 into a portion on the direction-B side and a portion on the direction +B side. Specifically, the rail section 62 includes a first rail member 64 and a second rail member 72.

On the side frame 32, the first rail member 64 is provided in the portion on the direction-B side with respect to the through hole 36. The first rail member 64 includes a longitudinal rail 65 and a sub rail 69 joined to the longitudinal rail 65.

The longitudinal rail 65 is open in the +Y direction toward the line head 40 and has a U-shaped section when viewed in the direction B. The longitudinal rail 65 extends substantially parallel to the direction B as a guiding direction.

The sub rail 69 has a U-shaped section open in the +Y direction and has a width similar to that of the longitudinal rail 65. The sub rail 69 extends in the +Z direction from a portion in which the sub rail 69 and the longitudinal rail 65 are joined. Here, when the two bearings 48 (FIG. 3) in the −Y direction are guided by the longitudinal rail 65 and the sub rail 69, the line head 40 is detachable from the first rail member 64 in the +Z direction.

The second rail member 72 is provided in the portion of the side frame 32 on the direction +B side with respect to the through hole 36. The second rail member 72 includes a longitudinal rail 73 and a lateral rail 74.

The longitudinal rail 73 extends in the direction B. The lateral rail 74 extends in the direction A. That is, the longitudinal rail 73 and the lateral rail 74 are orthogonal to each other.

The lateral rail 74 has a U-shaped section open in the +Y direction toward the capping unit 80 (FIG. 1) and extends parallel to the direction A as the guiding direction. The lateral rail 74 is divided at a portion in which the lateral rail 74 intersects the longitudinal rail 73.

The longitudinal rails 65 and 73 guide the bearing 48 (FIG. 3) in the direction B. That is, the longitudinal rails 65 and 73 guide the line head 40 in the direction B. The lateral rail 74 guides the capping unit 80 in the direction A.

The side frame 34 (FIG. 2) includes a guide member (not illustrated). Although the guide member has no through hole 36, the guide member and the rail section 62 are formed to be substantially symmetrical with respect to a virtual plane (not illustrated) that passes through the center of the apparatus main body 2 in the Y direction and that is orthogonal to the Y direction. Thus, illustration and description of the guide member of the side frame 34 will be omitted.

As illustrated in FIG. 5, the capping unit 80 is provided in the apparatus main body 2 so as to be movable in the direction A toward a facing position described later. Specifically, a driving mechanism (not illustrated) including a rack and a pinion enables the capping unit 80 to reciprocate in the direction A.

When the line head 40 moves to the recording position, the capping unit 80 retreats in the direction-A with respect to the line head 40. When the line head 40 is at the retreat position described later, the capping unit 80 moves in the direction +A so as to cover the plurality of nozzles N and performs maintenance of the line head 40 at the facing position described later.

As an example of a maintenance operation, the capping unit 80 collects the ink K ejected from the plurality of nozzles N. The ink K collected by the capping unit 80 is transferred to the waste-liquid accumulation section 16 (FIG. 1).

Specifically, the capping unit 80 includes a movable frame 82, the cover section 84 that is detachably attached to the movable frame 82, and a coupling tube 86.

The movable frame 82 has an L-shape when viewed in the Y direction. A protrusion (not illustrated) that protrudes outward in the Y direction is provided on each end surface of the movable frame 82 in the Y direction. The protrusion is guided by the lateral rail 74 (FIG. 4) in the direction A. A collection path (not illustrated) on which the ink K to be collected flows is formed in a portion of the movable frame 82.

The cover section 84 is an example of the maintenance section or the first maintenance section and has a box shape open in the direction −B. The direction +B bottom of the cover section 84 engages a portion of the movable frame 82 and is thereby attached to the movable frame 82. Disengagement of the cover section 84 from the portion of the movable frame 82 enables the cover section 84 to be detached from the movable frame 82.

The coupling tube 86 is a cylindrical flexible member and communicates with an interior space of the cover section 84. The coupling tube 86 guides the ink K in the cover section 84 to the collection path (not illustrated) of the movable frame 82. An axial end of the coupling tube 86 engages a portion of the movable frame 82 and is thereby attached to the movable frame 82. Disengagement of the axial end of the coupling tube 86 from the portion of the movable frame 82 enables the coupling tube 86 to be detached from the movable frame 82.

As illustrated in FIG. 6, a position of the cover section 84 when facing the line head 40, which is at the retreat position, in the direction B is the facing position. A position at which the cover section 84 retreats from the ejection surface 42 and which is in a downward direction with respect to the facing position is a non-facing position. The cover section 84 is provided to be movable between the facing position and the non-facing position. The cover section 84 performs maintenance of the line head 40 at the facing position.

The cover section 84 at the facing position is in a state of covering the nozzles N. In this state, the ink K ejected from the nozzles N is collected in the cover section 84. Note that periodic ejection of the ink K from the nozzles N suppresses an increase in viscosity of the ink K in the nozzles N.

The cover section 84 arranged at the facing position is located between a first guide rail 35 and a second guide rail 37 described later. Further, the cover section 84 is able to be removed in the upward direction from between the line head 40 and the second guide rail 37.

As illustrated in FIG. 5, the position at which the cover section 84 is away from the facing position in the direction-A is the non-facing position of the cover section 84. At the non-facing position of the cover section 84, the line head 40 and the cover section 84 do not interfere with each other, and the line head 40 is thus movable in the direction +B toward the transport unit 10.

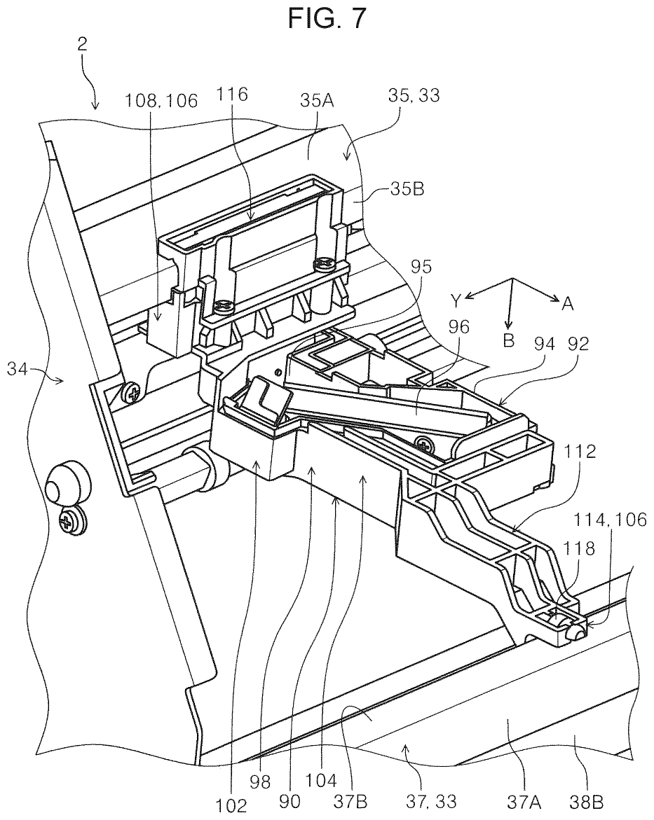

As illustrated in FIG. 7, the guide section 33 for guiding the wiper unit 90 in the Y direction is provided in the apparatus main body 2. The guide section 33 includes, for example, the first guide rail 35 and the second guide rail 37 that are arranged to be parallel to each other in the Y direction.

The first guide rail 35 is an example of a first guide and extends in the Y direction. The first guide rail 35 functions as a main shaft for guiding the wiper unit 90 in the Y direction. Specifically, the first guide rail 35 is formed of, for example, sheet metal having an L-shaped section in the A-B plane and includes a plate section 35A and a plate section 35B.

The plate section 35A has a predetermined thickness in the direction B and extends in the Y direction in the A-Y plane. The direction-A end of the plate section 35A is formed to be integrated with the aforementioned lateral frame (not illustrated).

The plate section 35B extends from the direction +A end of the plate section 35A in the direction +B. The plate section 35B has a predetermined thickness in the direction A and extends in the Y direction in the B-Y plane. A dimension of the plate section 35B in the direction B is shorter than a dimension of the plate section 35A in the direction A.

The second guide rail 37, which is an example of the second guide, is arranged to be spaced apart from the first guide rail 35 and extends in the Y direction. The second guide rail 37 is located in the direction +A and the direction +B with respect to the first guide rail 35. In other words, the second guide rail 37 is located in the +Z direction with respect to the first guide rail 35, that is, in an upward direction with respect to the first guide rail 35 in the Z direction. Further, the second guide rail 37 functions as a sub shaft for guiding the wiper unit 90 in the Y direction. Specifically, the second guide rail 37 is formed of, for example, sheet metal having an L-shaped section in the A-B plane and includes an attachment section 37A and a plate section 37B.

The attachment section 37A has a predetermined thickness in the direction A and extends in the Y direction in the B-Y plane. The direction +B end of the attachment section 37A is fixed to, for example, the lateral frame 38B.

The plate section 37B extends from the direction −B end of the attachment section 37A in the direction-A. The plate section 37B has a predetermined thickness in the direction B and extends in the Y direction in the A-Y plane. A dimension of the plate section 37B in the direction A is shorter than a dimension of the attachment section 37A in the direction B.

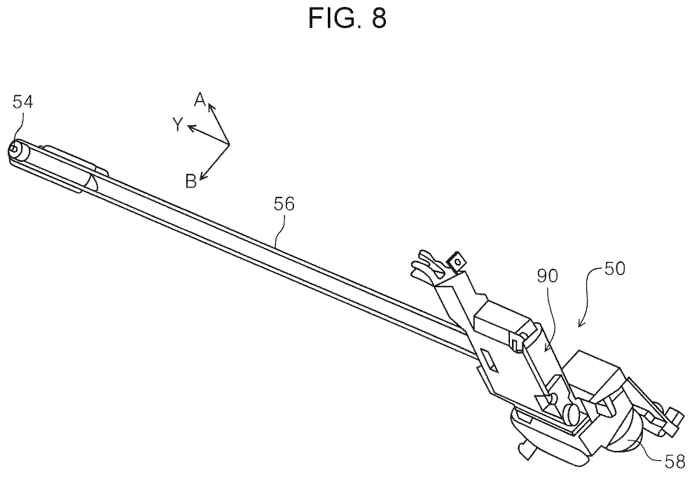

The wiper unit 90 is an example of a second maintenance section for performing maintenance of the line head 40 (FIG. 1) and functions as an example of a cleaning section for cleaning the ejection surface 42 (FIG. 3). The wiper unit 90 is provided to be movable in the Y direction by the driving unit 50 (FIG. 8).

When the line head 40 moves to the recording position, the wiper unit 90 retreats in the −Y direction with respect to the line head 40. In a state in which the line head 40 is at the retreat position, the wiper unit 90 temporarily moves in the +Y direction and cleans the ejection surface 42 while moving in the −Y direction. In this manner, the wiper unit 90 scrapes off the ink K attached to the ejection surface 42.

As illustrated in FIG. 8, the driving unit 50 is an example of a driving section and drives the wiper unit 90 in the Y direction. Specifically, the driving unit 50 includes a pair of pulleys 54, a timing belt 56, and a motor section 58 for rotating one of the pulleys 54. Note that the one of the pulleys 54 is not illustrated in FIG. 8, but the other of the pulleys 54 is illustrated in FIG. 8. The timing belt 56 is wound around the two pulleys 54. A portion of the timing belt 56 is fixed to a first guided section 108 (FIG. 7) of a wiper carriage 98 described later.

When the motor section 58 causes the one of the pulleys 54 to rotate forward, the wiper unit 90 is driven in the +Y direction. When the motor section 58 causes the one of the pulleys 54 to rotate in reverse, the wiper unit 90 is driven in the −Y direction. In this manner, the wiper unit 90 is movable between a cleaning position (FIG. 9) at which a cleaning operation for the line head 40 (FIG. 3) is able to be performed and a non-cleaning position (FIG. 4) away from the cleaning position. Note that the wiper unit 90 is arranged in a state of being inclined in the direction A orthogonal to the direction B when viewed in the Y direction.

As illustrated in FIG. 5, when the line head 40 moves to the recording position, the wiper unit 90 retreats in the −Y direction with respect to the line head 40 and is thus arranged at the non-maintenance position.

As illustrated in FIG. 9, in a state in which the line head 40 is at the retreat position, the wiper unit 90 temporarily moves in the +Y direction, then reaches the maintenance position while moving in the −Y direction and cleans the ejection surface 42.

As illustrated in FIG. 7, the wiper unit 90 includes a blade unit 92 and the wiper carriage 98.

The blade unit 92 includes, for example, a unit main body 94 and a blade 96. The unit main body 94 includes an ink storage section 95. Here, the ink K scraped by the blade 96 from the ejection surface 42 (FIG. 3) is stored in the ink storage section 95.

The wiper carriage 98 supports the blade unit 92 in the direction B. Specifically, the wiper carriage 98 includes a first frame member 102 and a second frame member 116.

The first frame member 102 includes a mounting section 104, the first guided section 108, an arm section 112, and a second guided section 114. The first guided section 108 and the second guided section 114 are collectively referred to as a guided section 106. The guided section 106 is guided in the Y direction upon coming into contact with the guide section 33.

The blade unit 92 is mounted on the mounting section 104.

The first guided section 108 is an example of the guided section and stands upright in the direction −B from the direction-A end of the mounting section 104. A portion of the timing belt 56 (FIG. 8) is attached to the first guided section 108. In other words, the first guided section 108 receives a driving force from the driving unit 50 (FIG. 8). Further, the first guided section 108 is guided by the first guide rail 35 to move in the Y direction.

The arm section 112 extends from the direction +A end of the mounting section 104 in the direction +A.

The second guided section 114 is formed at the direction +A end of the arm section 112. A roller 118 in contact with the second guide rail 37 is rotatably provided for the second guided section 114. Further, the second guided section 114 is guided by the second guide rail 37.

When the second frame member 116 is attached to the first guided section 108, a portion of the first guide rail 35 is held between the second frame member 116 and the first guided section 108 in the direction B.

In this manner, the wiper carriage 98 is configured to be movable in the Y direction in a state in which the blade unit 92 is mounted on the wiper carriage 98.

FIG. 10 collectively illustrates the line head 40, the capping unit 80, and the wiper unit 90 to indicate an arrangement relationship therebetween.

The line head 40 moves between the recording position and the retreat position in the direction B.

In a state in which the line head 40 is at the retreat position, the capping unit 80 moves between the facing position and the non-facing position in the direction A. Note that, when the line head 40 moves to the first maintenance position in a state in which the capping unit 80 is at the facing position, the ejection surface 42 and the cover section 84 face each other in the direction B.

In a state in which the line head 40 is at the second maintenance position mentioned above, the wiper unit 90 moves between the cleaning position and the non-cleaning position in the Y direction.

A path on which the center of the line head 40 in the Y direction moves and which is indicated by a line segment coupling the recording position and the retreat position is a movement path TB of the line head 40. A path on which the center of the cover section 84 in the Y direction moves and which is indicated by a line segment coupling the facing position and the non-facing position is a movement path TA of the cover section 84. A path on which the center of the wiper unit 90 in the direction A moves and which is indicated by a line segment coupling the cleaning position and the non-cleaning position is a movement path TY of the wiper unit 90. Here, the movement paths TA, TB, and TY partially overlap each other. In FIG. 10, a point at which the movement paths TA, TB, and TY overlap is indicated by an intersection point Q.

As illustrated in FIG. 11, the removal section 120 is provided in the apparatus main body 2. The removal section 120 is an example of a space that is opened when the discharge tray 21 (FIG. 1) is detached from the apparatus main body 2. The removal section 120 in an open state enables the cover section 84 at the facing position described above to be removed toward the discharge section 3.

The removal section 120 is a portion of a space between the side frame 32 and the side frame 34 (FIG. 2) and includes a space between the line head 40 and the second guide rail 37. The removal section 120 further includes a space between the first guide rail 35 and the second guide rail 37.

Detaching the discharge tray 21 from the apparatus main body 2 when the line head 40 is at the retreat position exposes at least a portion of the space between the first guide rail 35 and the second guide rail 37. In other words, a portion of the first guide rail 35 and the second guide rail 37 is visible from the discharge section 3. It is possible to access the cover section 84 from the discharge section 3.

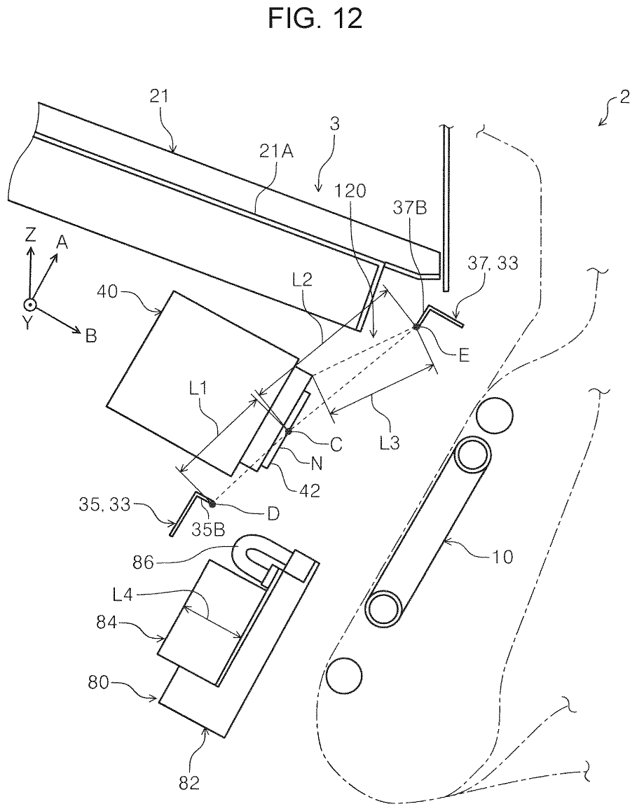

As illustrated in FIG. 12, in a state in which the line head 40 is at the retreat position, a distance L2 [mm] from a tip end position E of the second guide rail 37 to a central position C of the ejection surface 42 in the direction A is longer than a distance L1 [mm] from a tip end position D of the first guide rail 35 to the central position C when viewed in the Y direction.

The tip end position D is a position of the direction +B end of the plate section 35B. The tip end position E is a position of the direction-A end of the plate section 37B. Note that illustration of the wiper unit 90 (FIG. 9) will be omitted in FIG. 12.

A distance L3 [mm] corresponding to a minimum distance from the line head 40 at the retreat position to the tip end position E of the second guide rail 37 is longer than a distance L4 [mm] corresponding to a width of the cover section 84 in the direction B.

Next, operation of the printer 1 will be described with reference to FIGS. 1 to 12. Note that description of individual drawing number will be omitted.

In the printer 1, in a state in which the line head 40 is at the retreat position and in which the wiper unit 90 is at the non-cleaning position, the capping unit 80 is arranged at the facing position.

In this state, when the discharge tray 21 is detached from the apparatus main body 2, the removal section 120 is open and the cover section 84 is exposed.

The cover section 84 detached from the movable frame 82 is removed to the discharge section 3 through the removal section 120.

As described above, according to the printer 1, the discharge section 3 serving as a space to which the medium M subjected to recording by the line head 40 is discharged is located in the upward direction with respect to the discharge tray 21 in the printer 1. That is, a space is originally secured in the upward direction with respect to the discharge tray 21. When the discharge tray 21 is detached from the apparatus main body 2, the cover section 84 at the facing position is exposed when viewed from the discharge section 3. In this manner, even when no operation space is secured around the printer 1, the cover section 84 is able to be removed by using the space in the upward direction with respect to the discharge tray 21 of the printer 1, thus making it possible to easily replace the cover section 84.

According to the printer 1, even with a configuration in which the wiper unit 90 different from the cover section 84 is provided, the cover section 84 is able to be removed through a space between the line head 40 and the second guide rail 37.

According to the printer 1, since the cover section 84 in a state of being arranged at the facing position is located between the first guide rail 35 and the second guide rail 37, the cover section 84 is able to be removed from between the first guide rail 35 and the second guide rail 37.

Thus, it is possible to easily remove the cover section 84 compared with a configuration in which the cover section 84 is removed after the cover section 84 is moved to a position different from the facing position.

According to the printer 1, the second guide rail 37 is located in the upward direction with respect to the first guide rail 35 in the Z direction. In a state in which the line head 40 is at the retreat position, the distance L2 from the second guide rail 37 to the central position C of the ejection surface 42 is longer than the distance L1 from the first guide rail 35 to the central position C. Accordingly, it is possible to secure a greater distance between the line head 40 and the second guide rail 37 compared with a configuration in which the first guide rail 35 is located in an upward direction with respect to the second guide rail 37, thus making it possible to easily remove the cover section 84.

According to the printer 1, the first guided section 108 is located in a downward direction with respect to the second guided section 114, which is guided by the second guide rail 37, in the Z direction. When the first guided section 108 receives a driving force from the driving unit 50, the cover section 84 moves in the Y direction. Accordingly, a configuration in which the driving force is applied from the driving unit 50 to the first guided section 108 suppresses the cover section 84 to be removed from being interfered, thus making it possible to easily remove the cover section 84 compared with a configuration in which a driving force is applied to the second guided section 114.

According to the printer 1, without the line head 40 being moved at the retreat position farther, the cover section 84 is able to be removed from between the line head 40 and the second guide rail 37.

According to the printer 1, the cover section 84 and the line head 40 are able to be arranged close to each other compared with a configuration in which the movement path TA of the cover section 84 and the movement path TB of the line head 40 do not overlap, thus making it possible to reduce a size of the printer 1.

Although the printer 1 according to the embodiment of the disclosure basically has the above-described configuration, it is of course possible, for example, to partially change or omit the configuration without departing from the scope of the disclosure of the present application.

In the printer 1, the removal section 120 is not necessarily required to have a space between the line head 40 and the guide section 33. Moreover, the removal section 120 is not necessarily required to have a space between the first guide rail 35 and the second guide rail 37.

The cover section 84 in a state of being arranged at the facing position is not necessarily required to be located between the first guide rail 35 and the second guide rail 37.

The distance L2 may be the same as or shorter than the distance L1.

The driving unit 50 may apply a driving force not to the first guided section 108 but to the second guided section 114.

The distance L3 may be the same as or shorter than the distance L4. In such an instance, the removal section 120 may be increased in size, for example, by moving the line head 40 in the direction −B.

The wiper unit 90 may retreat not in the −Y direction but in the +Y direction.

The maintenance section is not limited to the cover section 84 and may be the entire capping unit 80. The maintenance section may be the wiper unit 90.

When the wiper unit 90 or another unit is used as the first maintenance section, the second maintenance section may be the cover section 84 or the capping unit 80.

The discharge tray 21 is not limited to one that is attached to or detached from the apparatus main body 2 and may be one that slides to retreat from above the cover section 84 and that slides to be located in an upward direction with respect to the cover section 84.

The movement path TA may entirely overlap the movement path TB.

The line head 40 is not necessarily required to move in the direction B. That is, the line head 40 may be fixed in the housing 2.

What is claimed is:

1. A printing apparatus comprising:
a recording section that performs recording on a medium by ejecting a liquid from an ejection surface inclined in an intersecting direction intersecting a vertical direction;
a maintenance section that is configured to move between a facing position at which the maintenance section faces the recording section and a non-facing position at which the maintenance section retreats from the ejection surface and which is located in a downward direction with respect to the facing position and that performs maintenance of the recording section at the facing position; and
a mounting section which is detachably provided in an upward direction with respect to the maintenance section and provided to an apparatus main body and on which the medium discharged is mounted in a state in which the mounting section is attached to the apparatus main body, wherein
the maintenance section is configured to be removed in an upward direction in a state in which the mounting section detached from the apparatus main body.

2. The printing apparatus according to claim 1, wherein the maintenance section is a first maintenance section, further comprising:
a second maintenance section that performs maintenance of the recording section; and
a first guide and a second guide that guide the second maintenance section in a third direction intersecting both a first direction in which the recording section moves and a second direction in which the first maintenance section moves, wherein
the second guide is located in an upward direction with respect to the first guide, and
the first maintenance section is configured to be removed in an upward direction from between the recording section and the second guide.

3. The printing apparatus according to claim 2, wherein
in a state in which the first maintenance section is arranged at the facing position, the first maintenance section is located between the first guide and the second guide.

4. The printing apparatus according to claim 2, wherein
a distance from the second guide to a central position of the ejection surface is longer than a distance from the first guide to the central position.

5. The printing apparatus according to claim 4,
further comprising a driving section that drives the second maintenance section in the third direction, wherein
the second maintenance section includes a guided section guided by the first guide, and
the guided section receives a driving force from the driving section.

6. The printing apparatus according to claim 2, wherein
a distance corresponding to a minimum distance from the recording section to the second guide is longer than a distance corresponding to a width of the maintenance section in the first direction.

7. The printing apparatus according to claim 1, wherein
the recording section is configured to move between a recording position at which the recording section is configured to perform recording on the medium and a retreat position away from the recording position, and
a movement path of the maintenance section overlaps at least a portion of a movement path of the recording section.

8. The printing apparatus according to claim 1, wherein
the maintenance section is configured to be removed in an upward direction from a space that is opened when the mounting section is detached from the apparatus main body in a state in which the mounting section detached from the apparatus main body.
